(19) United States
(12) Patent Application Publication
(10) Pub. No.: US 2006/0061517 A1
(43) Pub. Date: Mar. 23, 2006

(54) Delivering pixels received at a lower data transfer rate over an interface that operates at a higher data transfer rate

(76) Inventors: Paul A. Jolly, Rescue, CA (US); Sylvia J. Downing, El Dorado Hills, CA (US); Richard Jensen, Fair Oaks, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/950,211

(22) Filed: Sep. 23, 2004

(51) Int. Cl. G09G 5/00

(52) U.S. Cl. 345/1.1

(57) ABSTRACT

A number of pixels are received at a pixel rate that corresponds to a lower data transfer rate. The received pixels are delivered for display on a display device, over an interface that operates at a higher data transfer rate. These pixels are delivered as part of a stream that includes one or more codes that have been inserted between each adjacent pair of pixels so that the pixels in the stream are still delivered at the pixel rate. Other embodiments are also described and claimed.

### FIELD OF THE INVENTION

An embodiment of the invention is directed to the digital processing of still images or video, for delivery to a display device.

### BACKGROUND

Images and video that are displayed by electronic systems, such as personal computers, are composed of picture elements or pixels that define a frame or image to be displayed. A frame may consist of over a million pixels and may be formed under control of the main data processing part of the system (e.g., by a central processing unit, CPU, running a program stored in main memory). Each frame may be temporarily stored in a frame buffer of the system, prior to being transferred to the display device.

To transfer a digital image for display on a conventional analog cathode ray tube (CRT) device, its pixels may be read from the frame buffer by a display controller on a line by line basis (corresponding to the horizontal lines of the screen). Those pixels are then converted from digital to analog form. The resulting analog signal, also referred to as an analog video signal, is transmitted via cable to the CRT drivers that control the intensity and color of individual locations on the screen. The voltage of the analog video signal, which varies continuously with time, translates directly into an intensity or color of a location on the screen.

In contrast to the analog display interface, a digital monitor has what is referred to as a “digital” interface. Examples of these types of interfaces are found in digital CRTs, flat panel displays, and digital televisions. In those cases, the pixel data fetched by the display controller is kept in digital/discrete time format while being transferred to the display device (e.g., via cable). The Digital Visual Interface (DVI) 1.0 Specification, by the Digital Display Working Group (DDWG), Portland, Oreg. (“DVI”), defines the connector and other parts of an example display interface for digital displays.

In many cases, the integrated circuit containing the display controller is a graphics controller device. A graphics controller device within a computer system typically includes dedicated hardware to perform certain compute intensive tasks in digital image processing, such as geometry processing, vertex processing, texture application, and rasterization to yield a frame (the latter being one of the tasks typically performed by the display controller section). A graphics controller may interface with the display device by having its digital output pixel stream converted or translated into the format and signaling of the display interface. Examples of digital interfaces for transferring video out of a display controller are the Accelerated Graphics Port (AGP) and the Digital Video Output (DVO) port, both used by graphics controllers from Intel Corp., Santa Clara, Calif. A separate integrated circuit package, typically sold by a third party (other than the one sourcing the display controller and the display device), may be installed, as a “receiver” device for the stream, that has the needed conversion circuitry to translate between, for example, DVO and DVI

A typical scenario for displaying an image by a computer system is as follows. A pixel pipeline within the graphics controller collects a number of sub-frames or sub-images and combines them into a final image. For example, consider a computer screen showing several different windows and a cursor, where each of these items or objects may be a separate sub-image that has been separately generated. This final frame is stored in the frame buffer, waiting to be transferred to the display device. At this point, the final frame may be in the same resolution as required by the display device. For example, if a display device has 1024×768 pixel resolution, then the final frame may also be in that format of 1024×768=768,432 pixels. In other cases, the frame buffer is smaller than the screen in which case the image may be centered or located in some corner of the screen, or it may be upscaled within the pixel pipeline (prior to being applied to the screen).

Due to the nature of the materials and circuitry that make up the screen, the control signals that are applied to activate the elements of the screen need to be repeatedly applied to refresh the screen, to thereby maintain the brightness and colors of the displayed images. For example, in a typical CRT, a refresh rate of at least 80 Hz may be needed. In that case, the buffered frame is copied to the display device 80 times per second. The display screen resolution places a further requirement on data transfer rate in the interfaces between the display controller and the display device. For the example above, in the case of a 1024×768 screen with a refresh rate of 80 Hz, the rate at which pixels should be transferred for each frame is at least 1024×768×80=62,914,560 pixels per second (approximately 63 MHz). The actual rate is greater, due to the need for transferring blanking information in addition to the pixels.

Conventional graphics controllers have the ability to obtain pixel streams from the frame buffer at different rates, to accommodate the needs of different types of display devices. In the case of earlier generation Intel graphics controllers, pixel data can be sent out of the graphics controller through the DVO port at different rates, depending on how the graphics controller has been configured by software. Since the display interface has different signaling requirements than the DVO port, a protocol conversion is performed from DVO to the display interface. For example, an AGP digital display card (ADD Card) can be used to provide the needed translation from DVO/AGP to different types of display interfaces. In that case, a required pixel rate of for example 50 MHz is met by a DVO data transfer rate of 50×8=400 MHz (where in this case each pixel is represented by 8 binary bits). The ADD Card translates this 50 MHz DVO pixel input into a 50 MHz DVI pixel output. If a different display device were connected to the DVI interface, then software within the system would configure the graphics controller to change its DVO pixel rate (e.g., decrease from 50 MHz to 25 MHz). The DVO port in that case would drop the data transfer rate to 25×8=200 MHz, as would the DVI interface (via the ADD Card). Thus, the earlier generation DVO port had the capability to reduce its data transfer rate to that required by a given pixel rate.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 depicts an original pixel stream obtained from a frame buffer at a lower data transfer rate, that is translated to a new pixel stream at a higher data transfer rate, featuring pixel stuffing according to an embodiment of the invention.

FIG. 2 shows an example technique for replicating timing codes, and pixel stuffing with fill codes, according to another embodiment of the invention.

FIG. 3 shows a diagram of an example frame to be delivered for display over an integrated circuit interface between a graphics controller and a converter/receiver.

FIG. 4 is a block diagram showing pixel and timing paths starting from a pixel pipeline and passing on to two different video display interfaces.

FIG. 5 is a block diagram of a computer system featuring a graphics controller device and a protocol converter device according to an embodiment of the invention.

FIG. 6 illustrates an add-in card with a protocol converter integrated circuit package installed, together with a connector to a motherboard and a connector to a digital monitor interface cable.

FIG. 7 is a block diagram of an example protocol converter.

### DETAILED DESCRIPTION

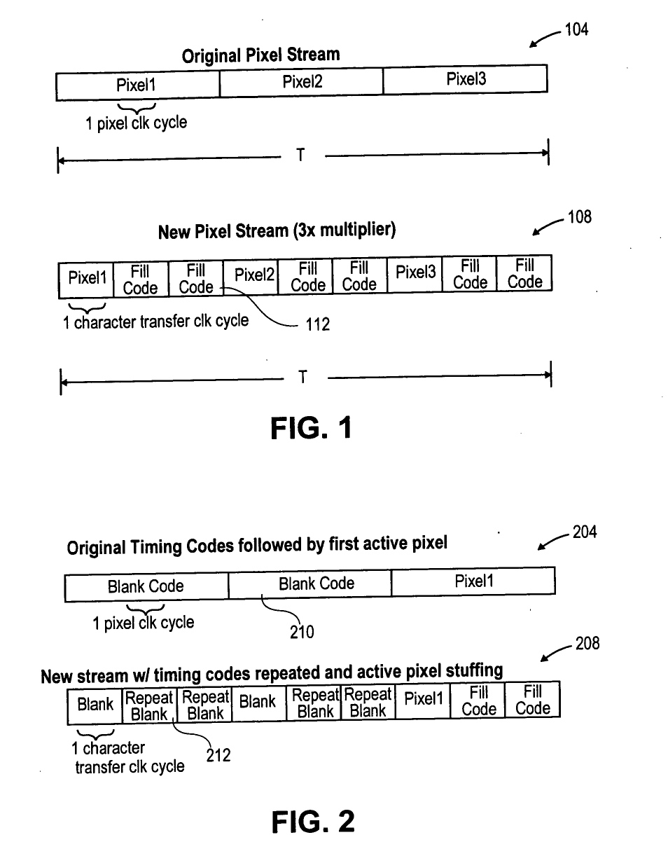

Beginning with FIG. 1, an original pixel stream and a new pixel stream obtained by a method for displaying pixels according to an embodiment of the invention is shown. According to such a methodology, an original pixel stream 104 is received at a “lower” data transfer rate. In this example, the original pixel stream includes a sequence of equal sized pixels, pixel1, pixel2, pixel3, . . . where the pixel rate is 60 mega pixels per second, or 60 MHz. If each pixel consists of 8 bits, then the lower data transfer rate in this case is 8×60 MHz=480 MHz. Note that the numbers as used in this description (e.g., frequency, multiplier, bit count) are merely to help the reader understand the various embodiments of the invention, not limit them.

The received pixels are then delivered for display on a display device (not shown), over an interface that operates at a “higher” data transfer rate. The received pixels are part of a new pixel stream 108 that is being transferred at, in this example, 3 times the lower data transfer rate. Each of the pixels from the original pixel stream has been squeezed into a clock cycle that is ⅓ as long as the original pixel clock cycle. However, the effective pixel rate in the new pixel stream is still the same, namely 60 MHz. One or more fill codes 112 have been inserted between each adjacent pair of pixels. To achieve an integer multiplier effect (in this case, a 3× multiplier), two fill codes 112 are inserted between pixel1 and pixel2 where each inserted fill code is the same size as a single pixel. As a result, the time interval T for transferring both streams may be essentially equal.

The above-described method may be used between the display controller and a display device of a computer system, for sending pixel data and display timings to one or more display devices. The method is useful when one of the interfaces to the display devices requires that a higher data rate be maintained, i.e., higher in relation to a data transfer rate dictated by the display resolution and refresh requirements at which the pixel data has been received. One reason why the interface to the display device (or simply referred to here as display interface) requires a higher data rate may be that the interface is AC coupled and as a result needs the data transfer rate to be maintained above a pre-determined threshold, due to its high pass filter effect.

For example, consider the serial digital video out (SDVO) interface found on current generation graphics and memory controller hub products by Intel Corp. SDVO refers to the second generation of graphics controller digital display channels by Intel, the first being DVO. SDVO provides digital display data in a serialized format, in contrast to DVO which is a parallel interface. In many cases, a protocol converter, such as a SDVO receiver device provided by a third party vendor, accepts the serialized SDVO format and translates the pixel stream into the appropriate format for the display interface (these embodiments will be further described below). SDVO currently calls for a symbol or character transfer rate that is between 100 MHz and 200 MHz. If each character symbol were a single pixel, then the above-described pixel stuffing methodology helps maintain the higher character transfer rate on the display interface, while maintaining the lower, original pixel rate. As described further below, this may be used in another embodiment of the invention to simplify the design of a receiver device (e.g., one that can simultaneously send the pixel data over a digital display interface and an analog display interface in a cost-efficient manner).

There are several different “transfer rates” that are being used here to describe the different embodiments of the invention. First, there is “pixel rate” which gives the number of pixels per second that are to be displayed. This rate may depend upon the display resolution and the refresh rate, as well as other factors such as blanking intervals and over scan compensation. Referring to FIG. 1, note that both the original pixel stream and the new pixel stream deliver the pixels at the same pixel rate, here, 60 MHz, although the new pixel stream is being transferred at a higher character transfer rate.

Still referring to FIG. 1, the new pixel stream is said to operate at a “character transfer rate” that is 3 times that of the original pixel stream. This means the new pixel stream contains three characters in the same time interval needed by the original pixel stream to transfer a single pixel.

Finally, the term “data transfer rate” refers to bit rate. Here, a character or symbol (e.g., a pixel; a fill code) may consist of a fixed number of bits (where in the above example, each pixel consists of 8 bits). Note that a “bit” here refers to two or more states, such that it is not limited to a binary bit. If the pixel data is being transferred serially, then the data transfer rate of an interface is a integer multiple of its character transfer rate. As another example, if each 8 bit character is encoded into a 10 bit symbol before being transferred, the data transfer rate in that case would be 10 times the character transfer rate (as in SDVO). The table below shows the relationship between pixel rates, character transfer rate (also referred to as clock rate), and data transfer rate for displaying 5 different pixel rates. The pixels are received at the pixel rate (PR), for display over an interface that operates at a “higher” data transfer rate, in the example range of 100-200 MHz.

TABLE 1

| | | Character Transfer | | | |
|---|---|---|---|---|---|
| Pixel Rate | | Rate or Clock Rate | Data Transfer Rate - | Data | |
| (PR) | | (CR) - Multiplier | Multiplier | Stuffing? | Stuffing Format |
| 25 to 40 | MP/s | 125 to 200 MHz - 5 × PR | 1.25 to 2.00 GHz - 10 × CR | Yes | Data, Fill, Fill, Fill, Fill |
| 25 to 50 | MP/s | 100 to 200 MHz - 4 × PR | 1.00 to 2.00 GHz - 10 × CR | Yes | Data, Fill, Fill, Fill |
| >50 to 60 | MP/s | 150 to 180 MHz - 3 × PR | 1.50 to 1.80 GHz - 10 × CR | Yes | Data, Fill, Fill |
| >50 to 100 | MP/s | 100 to 200 MHz - 2 × PR | 1.00 to 2.00 GHz - 10 × CR | Yes | Data, Fill |
| >100 to 200 | MP/s | 100 to 200 MHz - 1 × PR | 1.00 to 2.00 GHz - 10 × CR | No | Data |

For example, the pixel rate of 25 to 40 MP/s is translated to a character transfer rate (clock rate) of 125 to 200 MHz using a 5× multiplier. That means stuffing four fill codes following each received pixel. Although the pixel rate (PR) multipliers and clock rate (CR) multipliers are shown as integers, non-integer multipliers may alternatively be used albeit doing so may complicate the circuitry needed to implement the conversion. Upon receiving a request (such as from software running in the system) to change the pixel rate to a new rate, the number of codes that are inserted between each adjacent pair of pixels is changed in accordance with the new rate. For example, if the change is from a current pixel rate of 100 to 200 mega pixel per second to 50 mega pixel per second, then one option is to keep the character and data transfer rates unchanged while inserting a single fill code following each pixel in the original stream, so that there is enough data to fill the channel at the higher character and data transfer rates. Another option is to change to a lower CR and inserting 2, 3, or 4, fill codes (as appropriate) to fill the channel. The codes may be pixel-sized in that each code may have the same number of bits as a pixel. Each code may thus take about the same amount of time to transfer as a pixel. In addition, the codes may be inserted at regular intervals, such as between every pair of adjacent pixels of the original stream.

At the receiver end, the method for displaying pixels contemplates that the inserted codes will be detected (e.g., based on predefined patterns stored in the receiver), and used for receiver symbol alignment in the interface. The inserted fill codes may thus be designed to facilitate their detection for purposes of symbol alignment in a serial interface such as one that complies with the peripheral components interconnect (PCI) Express Base Specification 1.0a and Errata updated Jul. 14, 2004, available from PCI Special Interest Group (PCI-SIG) Portland, Oreg. 97221 (“PCI Express”). In other words, the received bit stream will be analyzed to determine the symbol boundaries, using previously stored data patterns that match the transmitted fill codes. In another embodiment, each fill code also provides error detection benefits, and may have a value such that a single bit error in any received pixel (or color value) is not likely to match a fill code, or that the fill code is not likely to be mistaken for a pixel.

The above described pixel stuffing methodology for displaying an image sequence may be combined with a further aspect where display timing data units are also included in the received pixel stream. For example, video pixel data may be sent during an “active” period, which is preceded by a “blank” period. This blank period may contain horizontal and vertical synchronization data units, conventionally used to indicate display timing for analog CRTs. These are also referred to as blank codes 210. Each blank code 210 may be the inverse of (e.g., one's complement in a binary system) a fill code. Referring now to FIG. 2, an original timing code stream 204 is shown that would be used with a 60 MHz pixel stream (see FIG. 1). The first pixel, pixel1, is preceded, in this example, by two blank codes 210. FIG. 2 also shows the new timing code stream 208, with inserted blank codes 212 that have been combined with active pixel stuffing according to FIG. 1. Note how each original blank code 210 has been shrunk down in size, just as the active pixel1. The inserted codes 212 in this case are repeated blank codes, namely replicates of the blank codes 210. In addition to maintaining proper display timing, using replicates of the blank codes helps reduce complexity of the converter/receiver device. The receiver device drops or ignores the repeat blanks, much like how the fill codes were ignored or dropped for pixels, so as to extract or reconstruct the original pixel stream for display at the intended pixel rate.

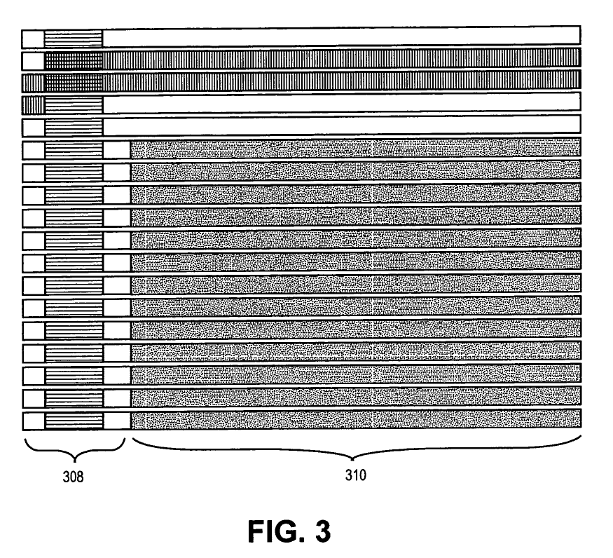

Turning now to FIG. 3, a block diagram of part of an example frame that may be subjected to the pixel stuffing methodology described here is shown. The frame is composed of a number of horizontal lines each containing a timing sequence 308 followed by an active pixel sequence 310. According to an embodiment of the invention, the frame shown would be delivered in essentially the same amount of time as it was received, to maintain the original pixel rate specified for the display device, except that the timing data units and pixels would be shrunk down to a fraction of the original pixel clock cycle and sent over a display interface that operates at a higher data transfer rate. In this example, each horizontal line of active pixels would be delivered with pixel stuffing (fill codes inserted, preceded by a sequence of timing codes having repeated blank codes inserted therein). In the case where the blank codes and fill codes are each the same size as a pixel, the resulting stream will flow at N times the character rate of the original pixel stream, where N is a positive integer greater than 1.

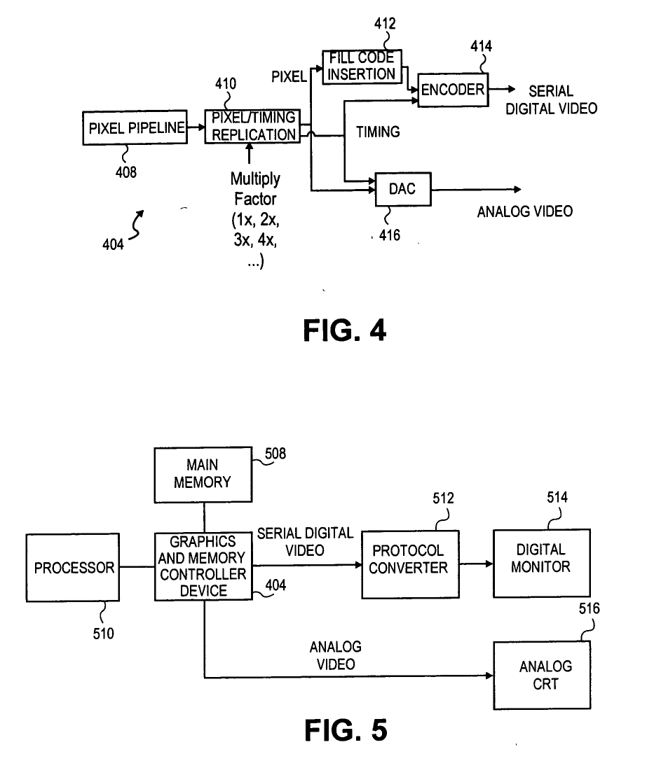

Turning now to FIG. 4, what is shown is a block diagram of the pixel and timing paths that may be taken starting from the pipeline that fetches the pixel data from a storage. This embodiment supports simultaneous display to an analog CRT monitor, for example. The logic depicted in FIG. 4 may be part of a graphics and memory controller device 404, and, in particular, the display controller portion. A pixel pipeline 408 is to blend sub-images or sub-frames from a number of sources, into an output frame to be displayed. These sources may include a frame buffer, a video buffer, and a hardware cursor (not shown). The resulting output frame may be stored in the frame buffer (not shown) prior to being fetched for display. This output frame may also have a number of timing data units embedded therein (such as shown above in FIG. 3), where these timing data units contain display timing information.

The pixel stream provided by the pixel pipeline 408 is sent to pixel timing replication logic 410. The logic 410 is to replicate the timing data units, as well as the pixels, in accordance with a multiplication factor. As explained above, the multiplication factor may be a positive integer greater than one. Thus, if a 3× factor were used to increase a pixel rate of 60 MHz to a character transfer rate of 180 MHz, a 3× multiplier used to duplicate the timing data unit. For example, if a blank period is two 60 MHz clocks in duration, it would be replicated to span six 180 MHz clocks.

The controller device 404 also includes fill codes insertion logic 412 that is designed to replace the replicate pixels with fill codes. As explained above, these fill codes may be selected to help synchronize the receiver of the stream, including use in, for example, symbol alignment logic and/or lane-to-lane deskew logic (not shown). In addition, these fill codes may be further designed to help with error detection at the receiver. For example, the fill code may be the 1's complement of a blank code, and selected such that no single-bit error in color (pixel value) matches a fill or blank code.

The output of the fill codes insertion logic 412 is combined with the timing signal (including timing data units) by an encoder 414 that includes encoding logic used to encode the output frame in accordance with a digital video transfer protocol. In this example, an encoding scheme referred to as 8B-10B may be used to deliver the output frame as part of a serial digital video stream over the SDVO interface.

The encoder 414 may encode each color channel of the output frame separately, such that each encoded color channel is assigned to a separate lane of a serial multi-lane point-to-point link (e.g., SDVO over PCI Express, where the SDVO protocol runs on top of physical layer interface circuitry that is in accordance with PCI Express). Other higher and lower layer protocols may alternatively be used in that interface.

The second path taken by the pixel and timing signals in FIG. 4 is through a digital to analog converter (DAC) 416. The pixel and timing signals are thus converted into analog form, in this case into an analog video signal where pixel intensity is proportional to the voltage of the analog signal. The DAC 416 may be integrated with the rest of the components of the controller device 404, on the same chip or in the same integrated circuit package.

As suggested above, the controller device 404 may be capable of supporting video transfer protocols with different programmable pixel rates, where each pixel rate is met by setting a respective clock or character rate that is a multiple of the pixel rate, and by setting a data transfer rate that is a multiple of the clock rate (see Table 1 describing the five different examples for pixel rates given above).

In operation, the controller device 404 splits a single pixel stream to be displayed into two simultaneous streams, where one is in the form of a serial digital video protocol such as SDVO, while the other is analog video. Note that the replication of pixels and timing data units, in this case, helps simplify the analog video portion, because it is a simple matter of digital to analog conversion of the serial stream directly, and then applying the resulting analog signals to the analog CRT. That may be because an analog CRT need not receive a clock, and its pixel data does not undergo the same encoding and parallel to serial conversion that a digital interface needs. For example, a pixel and its replicate together (in sequence) will appear the same as a single original pixel at one half the frequency.

The embodiments of the invention described above may provide one or more of the following advantages. First, the required frequency range on a high speed AC coupled interface such as SDVO may be narrowed while supporting a relatively broad range of pixel rates, thereby avoiding issues where the data transfer rate over the AC coupled bus is too slow for its coupling capacitors. In addition, using recognizable fill codes help the receiver device reconstruct the original pixel stream, and particularly where the fill codes have been selected with a view towards error detection and synchronization of the receiver. Note that in the multi-lane serial interface embodiment, the pixel stream may be divided over the multiple lanes of an AC coupled, multi-lane serial interface (such as one that complies with PCI Express). In that case, the fill codes may have the same size and values across all lanes. In addition, the fill code may be sent simultaneously on all lanes. This helps with error detection and synchronization at the receiver. In another embodiment described above where the active pixels are first replicated and then the replicates are replaced with fill codes, this feature helps efficiently implement the simultaneous display capability of an analog CRT monitor and a digital monitor.

An additional benefit of multiplying the pixel rate is that the receiver can more easily recover a clock from the received data stream, by increasing the edge rate within the stream and enabling data to be sent without a sideband clock. Also, in an SDVO embodiment, since SDVO encoding gives identical run lengths to 8b/10b encoding used in PCI Express, keeping the SDVO character rate similar to the PCI Express character rate allows the opportunity to re-use PCI Express circuitry on the transmitter and the receiver.

Turning now to FIG. 5, a block diagram of a computer system in which the pixel stuffing methodology for displaying images may be implemented. This system includes a processor 510 which may consist of one or more PENTIUM processors by Intel, a controller device 404 such as the graphics and memory controller HUB (GMCH) 915/925 by Intel, and main memory 508 (consisting, for example, of dynamic random access memory modules). This is known as a unified memory architecture (UMA) embodiment, because the frame buffer or memory region that stores the final frame for display is part of the main memory 508. The controller device 404 delivers a single pixel stream obtained from main memory, to both a protocol converter 512 via a serial digital video protocol, and an analog CRT 516 via an analog video interface. The protocol converter 512 serves to translate between, for example, SDVO and DVI, the latter being a popular display interface used by digital monitors 514. The digital display interface may also be one that complies with low voltage differential signaling (LVDS), which is a high speed, low power data transmission technique used to connect integrated flat panel displays in mobile/portable computing and communication devices (also referred to as “all in one type” devices). Yet another digital display interface is the High Definition Multimedia Interface (HDMI) 1.1, released May 2004.

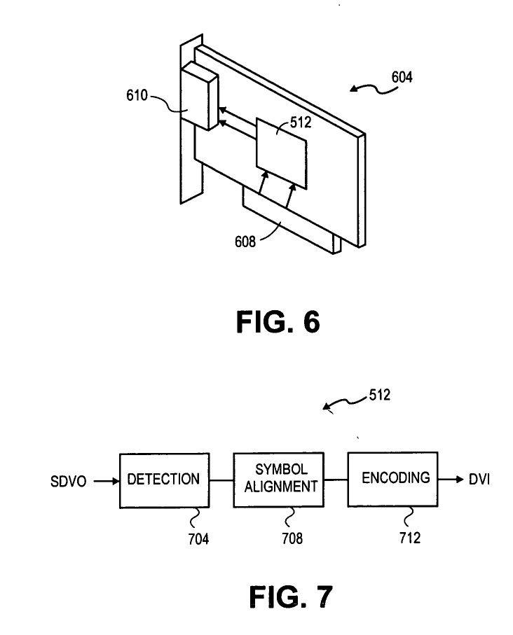

Turning now to FIG. 6, a block diagram of an add-in card 604 is shown on which the protocol converter 512 is installed. This card may be used to provide the needed translation from for example an SDVO interface to one or more other interfaces such as an analog video or a digital monitor interface (the latter referred to here as a DVI). The input to the protocol converter 512 could be in accordance with SDVO, from a motherboard connector 608. The connector 608 may be designed in accordance with for example the physical layer interface specification of PCI Express. The output of the protocol converter 512 feeds in this example a digital monitor interface cable connector 610. The connector 610 may be in accordance with the physical layer specification of DVI. In this example, there are two separate video channels, corresponding to two separate video streams that may operate simultaneously, that are received over the motherboard connector 608 and forwarded (after translation) to the monitor interface cable connector 610. As suggested above, an additional connector may be provided in certain embodiments of the invention, where an analog CRT (not shown) is to be simultaneously driven with a digital monitor.

A block diagram of some primary components of the protocol converter 512 is depicted in FIG. 7. This block diagram refers to the higher level functionality that is above the physical layer interface circuitry that is performed by the protocol converter. The logic functional blocks in cascade start with symbol detection 704, which “looks for” predetermined data patterns of fill codes and, in some cases, blank codes as well. In this example, the received stream of digital video that may include timing codes in addition to fill codes is in the form of SDVO. The detection logic 704 also signals the deletion or dropping of the detected fill codes and replicate blank codes before encoding, so that the original pixel rate may be recovered for sending to the display device. Next, symbol alignment of logic 708 uses the detected fill codes (and sometimes blank codes) to set symbol boundaries on the received data stream. The symbol alignment logic 708 may be used initially during a training period, to initialize the SDVO link, as well as subsequently during routine operation to verify or confirm alignment.

Once the fill codes and blank codes have been detected and the pixel stream is being reliably recognized at the output of the symbol alignment logic 708, encoding logic 712 forms a new sequence containing the pixels of the stream, to be sent to a display device. The example given above was 8B-10B, where 8 bit symbols are encoded into 10 bit characters before actually being transmitted by the physical layer interface circuitry (not shown). In some cases, the encoding logic 712 need not change the size of the symbols, but merely forms a new sequence containing the pixels, without the inserted fill codes and blank codes that have been detected.

Although the different embodiments of the invention are described above in terms of logic functional blocks, most, if not all, of the functionality described may be implemented by a programmed processor. In that case, a machine accessible medium would include instructions that when executed cause a machine (e.g., the display controller) to obtain digital video at a lower data transfer rate, and insert one or more blank codes for each timing data unit as well as one or more fill codes between pixels, to meet a predetermined higher data transfer rate. In addition, the instructions may also describe how to encode the pixels, the timing data units, and the blank and fill codes, in accordance with a digital video transfer protocol.

The invention is not limited to the specific embodiments described above. For example, although FIG. 3 refers to a frame that includes active pixels being fetched in a line-by-line manner preceded for each line by one or more blank codes, an alternative embodiment may have the blank codes embedded in other parts of the frame, or even provided as a separate signal. The inserted blank codes need not be replicates of the original timing data units. In addition, the display controller portion of a graphics controller may be integrated with a memory controller hub on the same integrated circuit as suggested above. Alternatively, however, the display controller portion may be in a separate integrated circuit package. Accordingly, other embodiments are within the scope of the claims.

What is claimed is:

1. A method comprising:
receiving a plurality of pixels at a pixel rate that corresponds to a lower data transfer rate; and
delivering the received pixels for display on a display device, over an interface that operates at a higher data transfer rate, together with one or more codes that have been inserted between each adjacent pair of pixels so that the received pixels are delivered at said pixel rate.

2. The method of claim 1 wherein in the interface, each inserted code is the same size as a pixel.

3. The method of claim 1 further comprising:
receiving a request to change the pixel rate to a new rate, and in response changing the number of codes that are inserted between each adjacent pair of pixels in accordance with the new rate.

4. The method of claim 1 wherein the interface is AC coupled and needs the higher data transfer rate to be maintained above a predetermined threshold.

5. The method of claim 1 wherein the codes are designed to assist in error detection.

6. The method of claim 1 wherein the received pixels are from a pixel pipeline that forms each frame of an image sequence as a combination of sub-images and transfers each frame from a main memory of a computer system.

7. A method comprising:
receiving an image sequence at a first rate;
generating a plurality of codes that include codes of a first type and codes of a second type, the second type codes, but not the first type codes, being replicates of timing data units found in the received image sequence; and
delivering the received image sequence for display on a first display device over a first interface as part of a stream that includes the plurality of codes, the stream being delivered over the first interface at a second rate that is greater than the first rate, while delivering the received image sequence for display on a second display device over an analog display interface at a third rate that is less than the second rate.

8. The method of claim 7 wherein the received image sequence is from a pixel pipeline that forms each frame of the image sequence as a combination of sub-images and transfers each frame from a main memory of a computer system.

9. The method of claim 7 wherein each of the first type codes is the same size as a pixel in the received image sequence,
and wherein the stream being delivered over the first interface has a sequence of pixels, first type codes, and second type codes that flows at N times the first rate where N is a positive integer greater than one.

10. The method of claim 7 wherein the first interface is a serial, AC coupled, digital video interface.

11. A method comprising:
receiving an image sequence at a lower data transfer rate; and
sending a stream that includes the received image sequence to a display device at a higher data transfer rate, wherein the stream includes a plurality of fill codes whose size and number are selected based on a pixel in the received image sequence and to meet the higher data transfer rate and whose values are selected for error detection at a receiver of the stream.

12. The method of claim 11 wherein the stream is divided over a plurality of lanes of an AC coupled multi-lane serial interface, and wherein the fill codes have the same size and values across the plurality of lanes.

13. The method of claim 11 wherein the stream includes a plurality of blank codes whose size and number are selected based on a timing data unit in the received image sequence and to meet the higher data transfer rate.

14. The method of claim 13 wherein the stream has a sequence of blank codes followed by pixels, with fill codes inserted in between the pixels, that flows at a character transfer rate that is N times a pixel rate in receiving the image sequence.

15. The method of claim 13 wherein the blank codes are replicates of timing data units in the received image sequence.

16. A method for displaying an image sequence comprising:
receiving a pixel sequence at a first data rate;
inserting a plurality of codes into the received pixel sequence to obtain a new pixel sequence that contains the inserted codes; and
sending the new pixel sequence for display on a first display device over a first interface, wherein the inserted codes help maintain a data rate of the new pixel sequence over the first interface above a predetermined threshold that is greater than the first rate.

17. The method of claim 16 wherein the plurality of codes are pixel-sized and are inserted at regular intervals.

18. The method of claim 17 wherein the data rate in the first interface is an integer multiple of the first rate.

19. The method of claim 17 wherein for each pixel in the received sequence, N−1 codes are inserted, and the data rate in the first interface is N times the first rate where N is a positive integer greater than one.

20. The method of claim 16 wherein the first rate is based on a display resolution and refresh rate of the first display device.

21. The method of claim 16 further comprising detecting the inserted codes and extracting the pixel sequence from the sent new pixel sequence, and sending the extracted pixel sequence to the first display device over a second interface.

22. The method of claim 21 wherein the extracted pixel sequence is sent over the second interface at the first data rate.

23. The method of claim 21 wherein the second interface is a digital visual interface (DVI).

24. The method of claim 16 further comprising detecting the inserted codes and using the detected codes for receiver symbol alignment in the first interface.

25. The method of claim 24 wherein the first interface is a serial digital video output (SDVO) interface.

26. A method comprising:
receiving an original pixel sequence according to a first pixel clock cycle; and
retiming and sending pixels of the received original pixel sequence as part of a new pixel sequence according to a second pixel clock cycle that is a fraction of the first cycle, with one or more fill codes being inserted so that the new pixel sequence is of approximately the same length of time as the original pixel sequence.

27. The method of claim 26 further comprising:
receiving an original display timing sequence, associated with the original pixel sequence, according to the first pixel clock cycle; and
retiming and sending timing data units of the received original display timing sequence as part of a new timing sequence according to the second pixel clock cycle, with one ore more blank codes inserted so that the new timing sequence is of approximately the same length of time as the original timing sequence.

28. The method of claim 27 wherein the fraction is 1/N where N is a positive integer greater than one.

29. The method of claim 26 further comprising:
receiving the new pixel sequence at a receiver interface and detecting a plurality of the inserted fill codes; and
using the detected fill codes to maintain synchronization of the receiver interface.

30. A graphics controller comprising:
a pixel pipeline to blend images from a plurality of sources into an output frame to be displayed, the output frame having a plurality of timing data units that contain display timing information and a plurality of pixels;
pixel and timing replication logic to replicate the plurality of timing data units and pixels;
fill code insertion logic to replace replicated pixels, from the replication logic, with fill codes; and
encoding logic to encode the output frame with the inserted fill codes and replicated timing data units in accordance with a digital video transfer protocol.

31. The graphics controller of claim 30 wherein the video transfer protocol supports a plurality of programmable pixel rates, each pixel rate being met by a respective clock rate that is a multiple of the pixel rate and by a data transfer rate that is a multiple of the clock rate.

32. The graphics controller of claim 30 wherein the encoding logic is to encode each color channel of the output frame separately, and wherein the digital video transfer protocol assigns each encoded color channel to a separate lane of a serial multi-lane point to point link.

33. The graphics controller of claim 30 further comprising a digital to analog converter to convert pixel and timing signals from the replication logic into an analog CRT signal where pixel intensity is proportional to the voltage of the analog CRT signal.

34. The graphics controller of claim 30 further comprising a PCI Express port, and wherein the interface encoding logic when enabled provides the output frame sequence through the PCI Express port in accordance with serial digital video output (SDVO) protocol.

35. The graphics controller of claim 30 wherein the pixel pipeline can be configured to provide the output frame at any one of a plurality of different pixel rates to match different display resolutions and refresh rates.

36. The graphics controller of claim 30 wherein each fill code has a value such that a single bit error in any received pixel is not likely to match the fill code.

37. The graphics controller of claim 30 wherein the each fill code has a value such that a received fill code with any single bit error is not likely to be mistaken for a pixel.

38. The graphics controller of claim 30 wherein each fill code is an inverse of a blank code.

39. A protocol converter comprising:
detection logic to detect a plurality of fill codes in a received stream of digital video that includes timing codes containing display timing data, pixels of an image sequence to be displayed in accordance with the display timing data, and one or more pixel-sized fill codes that were inserted between each adjacent pair of pixels to fill the stream so as to meet a data transfer rate of the stream;
symbol alignment logic to use the detected fill codes to set symbol boundaries on the received stream; and
encoding logic to form a new sequence containing said pixels to be sent to a display device.

40. The apparatus of claim 39 wherein the new sequence is in a format of one of the following types of interfaces: digital television, digital video interface (DVI), High Definition Multimedia Interface (HDMI) and low voltage differential signaling (LVDS).

41. The apparatus of claim 39 wherein said detection, symbol alignment, and encoding logic is installed on the same carrier substrate coupled between a first connector to receive the stream and a second connector to send the new sequence.

42. A system comprising:
a processor;
memory to store an application program for execution by the processor; and
a graphics controller to yield a frame requested by the application program and containing a plurality of pixels, the graphics controller having logic to obtain the frame from a pixel pipeline at a lower data transfer rate, logic to replicate the pixels, logic to replace the replicated pixels with fill codes, and logic to encode the plurality of pixels and the fill codes in accordance with a digital video transfer protocol having a higher data transfer rate.

43. The system of claim 42 wherein the graphics controller can provide geometry processing, vertex processing, texture application, and rasterization to yield the frame.

44. The system of claim 42 wherein the digital video transfer protocol is a serial multi-lane AC coupled point to point protocol.

45. The system of claim 42 wherein the graphics controller further includes a digital to analog converter to convert the plurality of pixels and the replicated pixels into an analog cathode ray tube (CRT) interface signal having the lower data transfer rate.

46. The system of claim 42 further comprising a memory controller hub, wherein the graphics controller is integrated with the memory controller hub in the same IC package.

47. The system of claim 42 further comprising a protocol converter to receive the encoded pixels and fill codes for the frame via the digital video transfer protocol, extract the encoded pixels, and re-send the extracted pixels without the fill codes to a display device at the same rate as the pixels were obtained from the pixel pipeline.

48. The system of claim 42 further comprising a protocol converter to receive the encoded pixels and fill codes for the frame via the digital video transfer protocol, and translate the received pixel and fill codes into an analog television input signal.

49. A machine-accessible medium comprising instructions that when executed cause a machine to obtain digital video at a lower data transfer rate, the digital video having a plurality of timing data units and a plurality of pixels, insert one or more blank codes for each timing data unit and one or more fill codes between pixels to meet a predetermined higher data transfer rate, and encode the plurality of pixels, the plurality of timing data units, and the blank and fill codes in accordance with a digital video transfer protocol.

50. The medium of claim 49 wherein the instructions cause the plurality of pixels and timing data units to be replicated, and then the replicate timing data units and replicate pixels replaced with said one or more blank codes and said one or more fill codes.

51. The medium of claim 50 further comprising instructions that cause the plurality of pixels, timing data units, replicate pixels and replicate timing data units to be sent to a digital to analog converter for conversion into an analog CRT interface signal.
